(19) United States
(12) Patent Application Publication
(10) Pub. No.: US 2017/0131987 A1
(43) Pub. Date: May 11, 2017

(54) Mobile Application Service Engine (MASE)

(71) Applicant: Relay2, Inc., Milpitas, CA (US)

(72) Inventors: Jihn-Shiarn Chen, Fremont, CA (US); Wai-Tak Siu, San Jose, CA (US); Wei Lu, Beijing (CN)

(73) Assignee: Relay2, Inc., Milpitas, CA (US)

(21) Appl. No.: 14/938,763

(22) Filed: Nov. 11, 2015

(51) Int. Cl. G06F 9/445

(52) U.S. Cl. CPC G06F 8/60

(57) ABSTRACT

Third party applications are deployed as “containerized applications” on one or more wireless AP devices. The containerized applications are confined to a pre-allocated segregated disk space within a file system of a given wireless AP device. The containerized applications have access to standard Linux services as well as access to advanced features provided by a given AP.

### TECHNICAL FIELD

The present invention is directed to wireless communications, and more specifically to aspects of WiFi network architecture and services.

### BRIEF DESCRIPTION OF THE DRAWINGS

FIG. 1 shows a high-level diagram that illustrates a cloud-controlled service-ready access point device architecture, according to certain embodiments.

FIG. 2 illustrates the cloud-controlled service-ready access point device architecture of FIG. 1 in greater detail, according to certain embodiments.

FIGS. 3A, 3B and 3C illustrate management of MASE applications, according to certain embodiments.

FIG. 4 illustrates MASE libraries to support MASE applications installed in a given AP device, according to certain embodiments.

FIG. 5 illustrates segregation of a portion of the AP file system to confine MASE applications, according to certain embodiments.

### DETAILED DESCRIPTION

Methods, systems, user interfaces, and other aspects of the invention are described. Reference will be made to certain embodiments of the invention, examples of which are illustrated in the accompanying drawings. While the invention will be described in conjunction with the embodiments, it will be understood that it is not intended to limit the invention to these particular embodiments alone. On the contrary, the invention is intended to cover alternatives, modifications and equivalents that are within the spirit and scope of the invention. The specification and drawings are, accordingly, to be regarded in an illustrative rather than a restrictive sense.

Moreover, in the following description, numerous specific details are set forth to provide a thorough understanding of the present invention. However, it will be apparent to one of ordinary skill in the art that the invention may be practiced without these particular details. In other instances, methods, procedures, components, and networks that are well known to those of ordinary skill in the art are not described in detail to avoid obscuring aspects of the present invention.

According to certain embodiments, a mobile application services engine (MASE) enables the deployment (in clusters or otherwise) of third party applications at access point devices (“AP”). According to certain embodiments, such a deployment of third party applications can be managed remotely using a cloud implemented network management system (cloud-based NMS). Further, the NMS can remotely monitor the activities and status of the third party applications deployed in one or more APs associated with the cloud-based NMS. A wireless access point (AP) is a device that allows wireless devices (client devices) to connect to a wired network using Wi-Fi, or related standards. An enterprise grade AP device includes a chipset that is capable of connecting hundreds of wireless client devices to a wired network at the same time.

According to certain embodiments, third party applications are deployed on a given AP using software containers (e.g., Linux containers). Such software containers provide a secure environment for the third party applications, while at the same time, protects the AP by confining a given third party application in an isolated file system as described in greater detail herein. The embodiments are not restricted to Linux containers. The type of containers may vary from implementation to implementation.

According to certain embodiments, such containers preserve the stability and quality of the AP without requiring the customer to override the AP's firmware and/or rebuild the AP's image files. A customer is any establishment or entity that owns or rents APs for deployment in the establishment/buildings. Thus, the customer can be either a retailer or a wireless service provider that deploys the access point device(s).

According to certain embodiments, applications can be grouped (clustered) such that applications of the same group share the same container in a given AP. Thus, application groups that are installed and run in separate containers can reduce interference and conflicts between the application groups.

According to certain embodiments, such third party applications in the containers (herein also referred to as “containerized applications” or “MASE applications”) have access to standard Linux services as well as access to advanced features provided by MASE through the MASE application interface (API) on a given AP. For example, standard Linux system services are available to the MASE applications using Linux system calls. Advanced system services are available to the MASE applications through the MASE API.

According to certain embodiments, a MASE application includes configuration files, any libraries and other binaries needed to run the software application, bundled into the container. According to certain embodiments, a given AP device shares the AP's operating system, CPU and memory with the MASE applications.

According to certain embodiments, a given AP device includes a MASE run-time management system to manage and monitor the MASE applications. For example, the MASE run-time management system monitors the use of a given AP's resources by each MASE application to prevent hogging of resources by the MASE applications. According to certain embodiments, in order for an AP device to host MASE applications and to host the MASE run-time management system, the AP device includes: 1) WLAN chipset that is capable of connecting at least about 50 wireless client devices at the same time to the wired network that is associated with the AP device (preferably, the WLAN chipset is capable of connecting at least 100 wireless client devices to the wired network that is associated with the AP device), 2) a stand-alone multi-core CPU (central processing unit) that is capable of hosting relevant WiFi related connection services for wireless client devices, as well as capable of hosting/supporting MASE applications, 3) high-speed and large RAM memory capable of hosting MASE applications on the AP device (e.g., RAM size ranges from approximately 1 gigabyte to approximately 4 gigabyte), 4) high-speed and large permanent storage (e.g., permanent storage size ranges from approximately 8 gigabyte to approximately 128 gigabyte) for supporting MASE applications and for storing large amounts of cached data to support better web-services delivery, and 5) dedicated network processor hardware that is capable of analyzing and controlling IP data packets and for controlling data traffic to achieve reasonable wirespeed in the associated wired network but without adversely impacting CPU cycles of the AP's CPU and without adversely impacting the run-time performance of the MASE applications that are running on the AP device.

According to certain embodiments, third party applications are installed on the one or more APs as MASE application packages using standard ipk packaging technology. The embodiments are not limited to ipk packaging (itsy package) technology. The type of packaging technology used may vary from implementation to implementation. An application package includes configuration files, software libraries and executable code, for example.

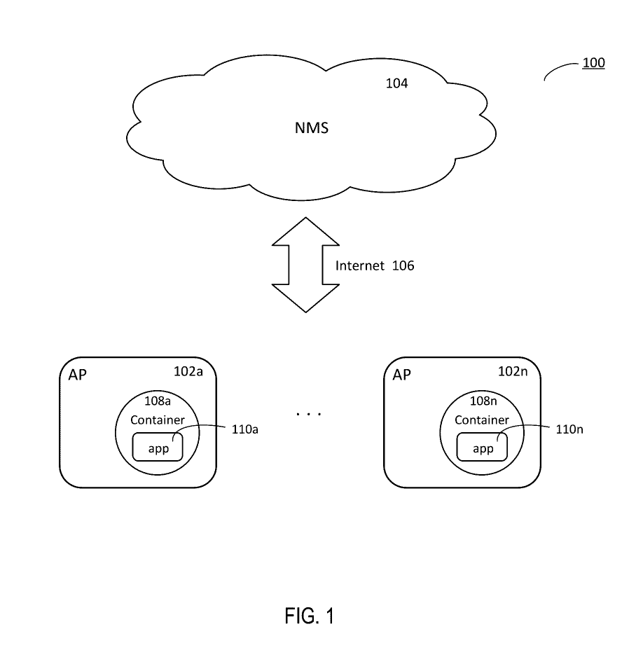

FIG. 1 shows a high-level diagram that illustrates a cloud-controlled service-ready access point device architecture 100, according to certain embodiments. FIG. 1 shows a plurality of cloud-controlled service-ready access point devices (AP) 102a, . . . , AP 102n and a cloud-based NMS 104.

AP 102a . . . AP 102n are associated with the cloud-based NMS 104 in a cloud infrastructure that supports the plurality of cloud-controlled service-ready access point devices. Each of AP 102a, . . . , AP 102n includes a respective container 108a, . . . , 108n, which in turn includes a respective application 110a, . . . , 110n. The applications 110a, . . . , 110n are MASE applications because they are containerized at the respective APs.

According to certain embodiments, each AP device can include one container or multiple containers. Further, each container can contain one MASE application or multiple MASE applications. For example, applications can be grouped so that the applications of the same group can share the same container in a given AP. Application groups that are installed and run in separate containers can reduce interference and conflicts between the application groups.

According to certain embodiments, the cloud-based NMS 104 has the following functions with respect to the MASE applications: 1) deploy the MASE applications in the one or more APs, 2) manage installation of the one or more MASE applications, 3) upgrade the one or more MASE applications when needed, 4) monitor the running status of the one or more MASE applications, 5) configure the one or more MASE applications, and 6) maintain the one or more MASE applications (e.g., the access to syslog files of MASE applications are implemented through the cloud-based NMS).

According to certain embodiments, the APs use open source Linux (OpenWRT). According to certain embodiments, third party developers use the MASE API and the MASE software development kit (SDK, which is based on the OpenWRT build environment) to develop the MASE application. The MASE SDK includes tools for third party developers to build MASE application packages and to download the application packages to the APs. The embodiments are not limited to the Linux OpenWRT operating system. The type of operating system used for the AP may vary from implementation to implementation. The MASE applications can be uploaded to the cloud-based NMS. According to certain embodiments, the Cloud based NMS provides an interactive GUI (graphical user interface) to facilitate the upload process.

According to certain embodiments, cloud-based NMS 104 is the network management system that manages clusters of APs. Cloud-based NMS 104 is responsible for the full cycle deployment of third party applications such that the applications can be managed remotely via cloud-based NMS 104 without any need of performing administrative tasks locally on the APs.

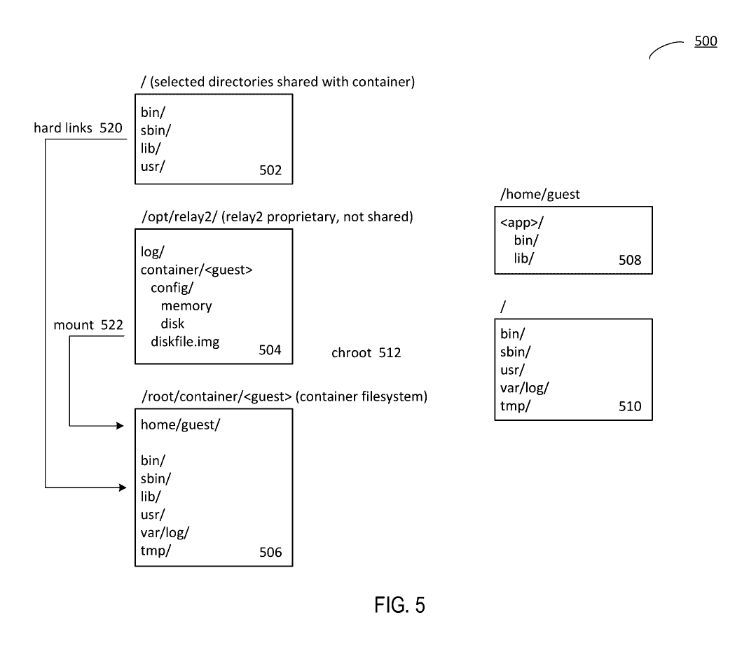

According to certain embodiments, MASE applications can be effectively “walled-off” by confining them to a pre-allocated a sub-file system of limited size within the AP file system as explained in greater detail herein with reference to FIG. 5, herein.

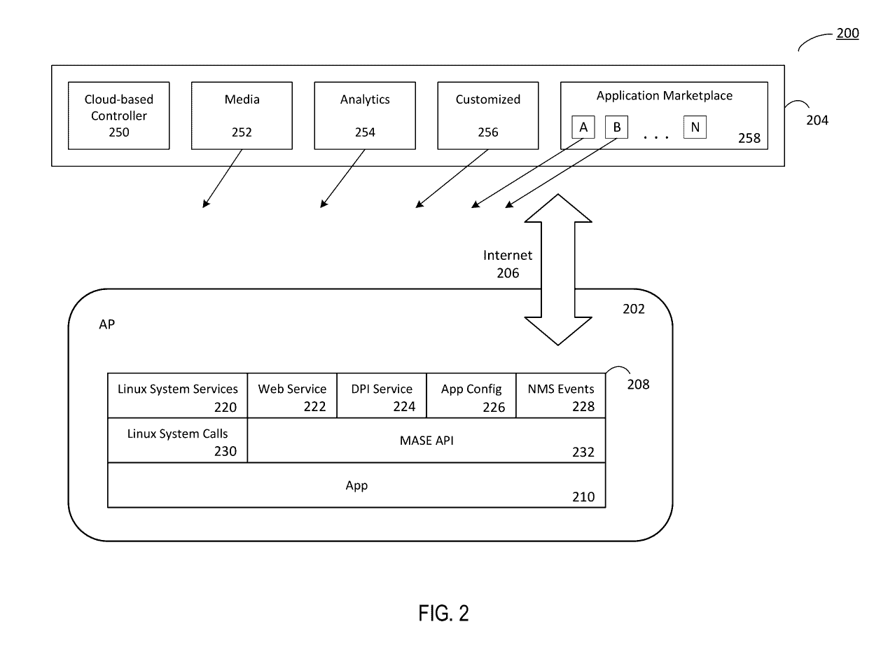

FIG. 2 illustrates the cloud-controlled service-ready access point device architecture 200 in greater detail, according to certain embodiments. For purposes of convenience, FIG. 2 shows only one of the APs of the plurality of APs.

In FIG. 2, cloud-based NMS 204 includes a cloud-based controller 250 and MASE applications that can be downloaded and installed on AP device 202. As non-limiting examples, the MASE applications stored in NMS 204 include media applications 252, analytics applications 254, customized applications 256, as well as various applications A-N in application marketplace 258 from which a customer can choose to download one or more applications A-N onto the AP device 202.

For purposes of explanation, assume that a customer that owns or leases AP device 202 would like to have several MASE applications downloaded to AP device 202.

According to certain embodiments, AP device (AP) 202 communicates with cloud-based NMS 204 through a secure tunnel in Internet 206, for example.

According to certain embodiments, non-limiting examples of characteristics of AP device 202 that include operating system services 220 (e.g., Linux system services), web service 222, deep packet inspection (DPI) service 224, application configuration 226, NMS events interface 228, operating system calls 230, MASE application programing interface 232 (MASE API), MASE application 210 (downloaded from cloud-based NMS 204). According to certain embodiments, an application configuration that is specific to an application for a specific AP or cluster of APs can be specified at the NMS and then downloaded to the specific AP or cluster of APs. The MASE API on the AP delivers the configuration to the relevant application using callbacks that the given MASE application registers with the MASE API, for example.

According to certain embodiments, AP device 202 also includes physical resources on the AP device such as a network processor, a WLAN chipset capable of connecting more than 50 wireless clients to a wired network at the same time, an AP RAM memory, permanent storage, AP multi-core central processing units (CPU), and an AP file system. Such physical resources are on the AP device.

Application marketplace 258 is a repository of third party applications that are developed using the MASE technology, according to certain embodiments.

Third party application developers use the MASE software development kit (SDK) to develop MASE applications that can be deployed in a given AP device. When the third party application developers upload their MASE applications to application marketplace 258, the third party application developers can define the type of MASE APs where the applications can be deployed. The third party application developers can define their applications as private or public applications. Private applications can only be deployed at APs that are managed by the same AP providers that the third party developers are associated with. Public applications can be deployed at any of the APs, and a licensing scheme is available for the third party developer to collect licensing fees from AP owners that deploy the public applications, according to certain embodiments.

Further, third party application developers can define the type of configuration that can be applied to the applications, such as the name of the configuration parameters, the type of the parameters and the range or possible values of the parameters. A configuration can be defined for a group of APs where the application is deployed, or a configuration can be defined for a specific AP.

According to certain embodiments, the MASE SDK includes the open source OpenWRT build environment, with which the third party developer can use to build the application and package the application in the standard ipk package. The SDK also includes the MASE API library and the header file, which can be included in the application if the third party developer decides to leverage the system services provided by the MASE API.

Further, the SDK includes a suite of tools that allow the third party developer to manage the installation of the applications of the third party developer on a MASE AP device as part of the development test bed. The MASE API is required to run in a developer mode, according to certain embodiments. When the developer mode is enabled, the AP handles the installation commands generated by the tool suite.

According to certain embodiments, AP owners can select MASE applications to be deployed on their APs. For example, AP owners can select either private applications that are developed by their own developers, or public applications that are developed by any third party developers. When the applications are selected to be deployed or installed on some APs, configurations can be specified for the group of APs based on the requirements of the particular deployments. Further, the AP owners can decide whether the applications, after they are installed on the APs, should start or stop running, or whether they should be restarted. The AP owners can do so by specifying the running status of the applications.

According to certain embodiments, the cloud-based NMS 204 implements different interfaces and tools for application maintenance. For example, the status and health of the MASE applications (as well as memory usage, CPU usage and disk usage) can be monitored at cloud-based NMS 204. The application status and health are updated consistently.

As another example, if MASE application 210 has crashed and is restarted, events are generated and can be reviewed at the NMS event log at cloud-based NMS 204. Application syslog message files are uploaded to the cloud-based NMS 204 and can be retrieved for review, for example.

According to certain embodiments, MASE applications 210 running in containers on the AP have access to standard Linux system services 220 such as the file system and internetworking features (for example, TCPIP protocol, UDP protocol, HTTP server connections, and various software libraries). In addition, advanced features such as Web services are available to the MASE applications via MASE API. Further, the MASE API 232 supports cloud-based application configuration and event logging. The embodiments are not limited to Linux operating systems. The type of operating systems may vary from implementation to implementation.

Third party MASE applications 210 deployed at APs have access to all standard Linux system services 220. Linux system services 220 include but are not limited to: 1) Pre-allocated disk space for a variety purposes such as application data storage, 2) IP internetworking through UNIX socket API, and 3) Standard UNIX sysloging service.

According to certain embodiments, MASE applications 210 are installed and run within the confinement of container 208. Container 208 is constructed based on Linux technologies, according to certain embodiments. For example, container 208 uses the same standard Linux tools and libraries built in the AP image from the OpenWRT distribution. Each MASE application 210 has pre-allocated disk space in an isolated file system inside the container. Each MASE application 210 has full read and write access to its dedicated pre-allocated disk space. However, the MASE application 210 has only read access outside its dedicated pre-allocated disk space within the container when running as a non-privileged user. The construction of container 208 may be based on other technologies and is not limited to Linux technologies and may vary from implementation to implementation.

According to certain embodiments, MASE applications 210 are packaged using the standard ipk package format that is used by the open source OpenWRT build environment. Application installation at a given AP is managed through the cloud-based NMS 204 remotely. Standard application installation scripts (e.g., preinst, postinst, prerm, postrm) are supported and invoked as applications are installed or uninstalled at a given AP, according to certain embodiments.

According to certain embodiments, the running status of a MASE application 210 is managed remotely at cloud-based NMS 204. The MASE application 210 is started or stopped using a service status management mechanism via application “init” script that is installed at location /etc/init.d/, for example. Init script commands, e.g., start, stop, restart, status, are used to manage the application status.

According to certain embodiments, while MASE applications 210 are running within the confinement of a container 208 on the AP, the MASE applications 210 have full access to other system resources on the AP such as the physical memory and CPU cycles of the AP. According to certain embodiments, a given MASE application 210 can specify the amount of system resources that the given MASE application needs in the application package manifest. According to certain embodiments, the amount of system resources are capped at a hard limit when the MASE application 210 is installed on the one or more APs. MASE applications 210 are more or less continuously monitored and can be restarted as soon as they are found to have used up too many AP resources based on the predefined limits, according to certain embodiments.

According to certain embodiments, application configuration is managed at cloud-based NMS 204. However, the configuration information 226 is eventually passed to the MASE application 210 via the MASE API 232. If the MASE application 210 requires configuration support from cloud-based NMS 204, the MASE application 210 can use the MASE API 232 in order to receive the application configuration information.

Web applications are server side applications that implement specific Web requests from wireless clients. According to certain embodiments, there are three models of web applications for accessing the web requests. According to certain embodiments, the three models of web applications for accessing the web requests are: 1) Proxy service model based on domain names specified by applications, 2) Static web content model, 3) FCGI applications model. MASE API 232 provides advanced HTTP proxy service based on proxy requirements specified by the MASE application 210. When HTTP proxy service is enabled for certain domain names, the HTTP requests are proxied and forwarded to proxy HTTP/TCP ports that the MASE application 210 specifies. The MASE application 210 can implement an HTTP server on such proxy HTTP/TCP ports to service the proxied HTTP requests received at those HTTP/TCP ports.

According to certain embodiments, Web service 222 can host static Web content packaged in the application ipk package. Third party developers can package Web content, such as HTML pages, Javascript programs, and multimedia files (pictures/audio/video) in the MASE application package together with a Web hosting manifest that specifies the base URL locations (including host names and base paths) for the Web content. When the MASE application 210 is installed, Web service 222 is reconfigured to support the URL locations specified in the Web hosting manifest.

According to certain embodiments, third party applications can implement the standard fast common gateway interface (FCGI). The FCGI applications are installed in the same Linux container environment as regular third party MASE applications on the APs, but are invoked as FCGI applications with Web service 222 handling the Web request before invoking the third party applications via the standard FCGI protocol. Web service 222 can be configured to invoke the third party applications for selected URLs based on FCGI Web hosting manifest, which is packaged together with the third party FCGI application in the application ipk package. For example, when a client device requests a web page or a video from the internet, web service 222 will check to see if there is a match in the URL list. If there is a match, web service 222 invokes the FCGI application, which in turn, will analyze the request from the client device and decide on the appropriate response to send to the client device.

According to certain embodiments, DPI service 224 supports DPI related applications by providing advanced flow-based packet sniffing. Packets can be captured on a per flow basis, with adjustments allowed to sniff more or fewer packets for a particular flow. In addition, DPI analytic applications can use the MASE API 232 to export statistics and reports to the cloud-based NMS 204. Cloud-based NMS 204 can provide cloud-based storage and GUI integration for display purposes.

According to certain embodiments, MASE API 232 allows the third party application to access various system services. For example, application configuration is managed at cloud-based NMS 204, which sends the configuration information to the relevant AP where the application is deployed. The configuration information is sent to the application via MASE API 232. As another example, for all the HTTP requests that the MASE application 210 would like Web service 222 to proxy on behalf of the MASE application 210, the MASE application 210 can specify the domain names of such URLs via the MASE API 232 together with the proxy HTTP/TCP port number. The MASE API 232 reconfigures the networking stack on the AP to proxy the HTTP requests destined for such domain names, and forwards the requests to the specified proxy HTTP/TCP ports. The third party application can implement a Web server on such proxy HTTP/TCP ports to receive the proxied HTTP requests. Further, flow-based packet sniffing is supported to capture packets for DPI analysis. Statistics and reports are exported to cloud-based NMS 204 for integration with cloud-based services provided by cloud-based NMS 204. In addition, cloud-based NMS 204 implements an event log to log various kinds of system events related to activities at the APs. MASE applications 210 can generate events using MASE API 232 so that such events can be logged at the event log in cloud-based NMS 204.

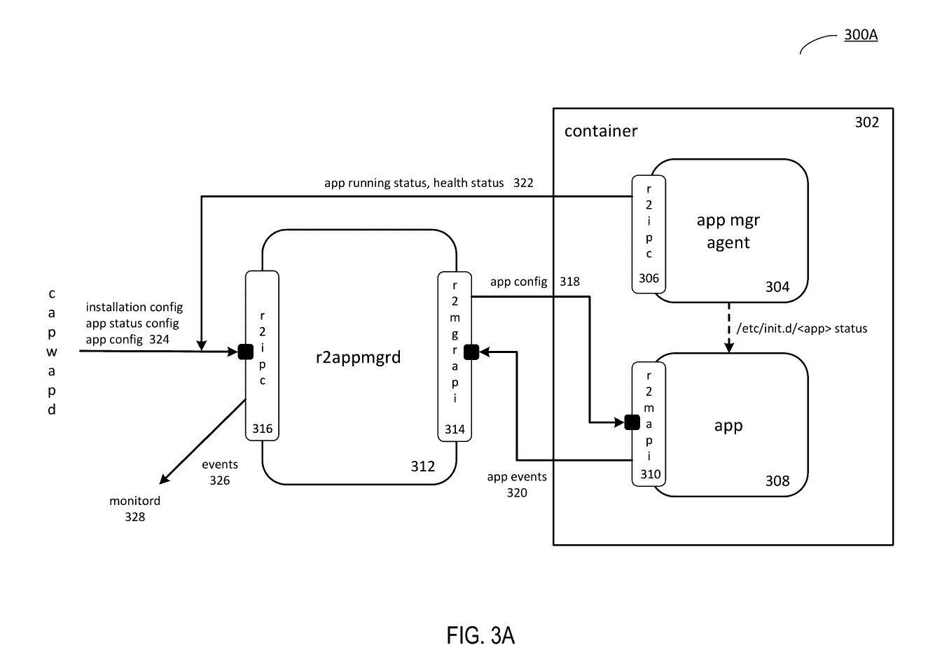

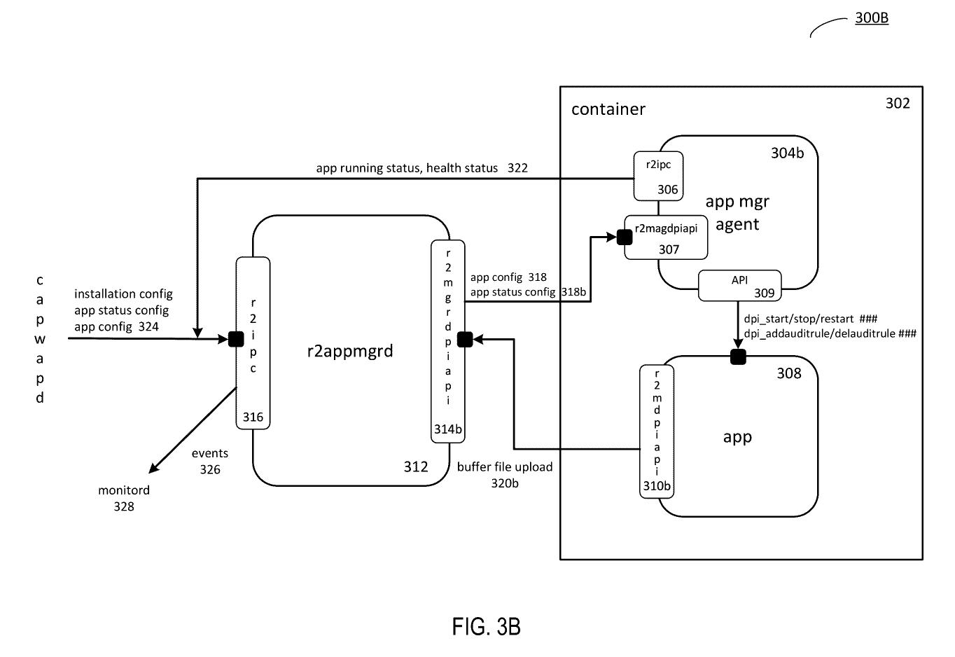

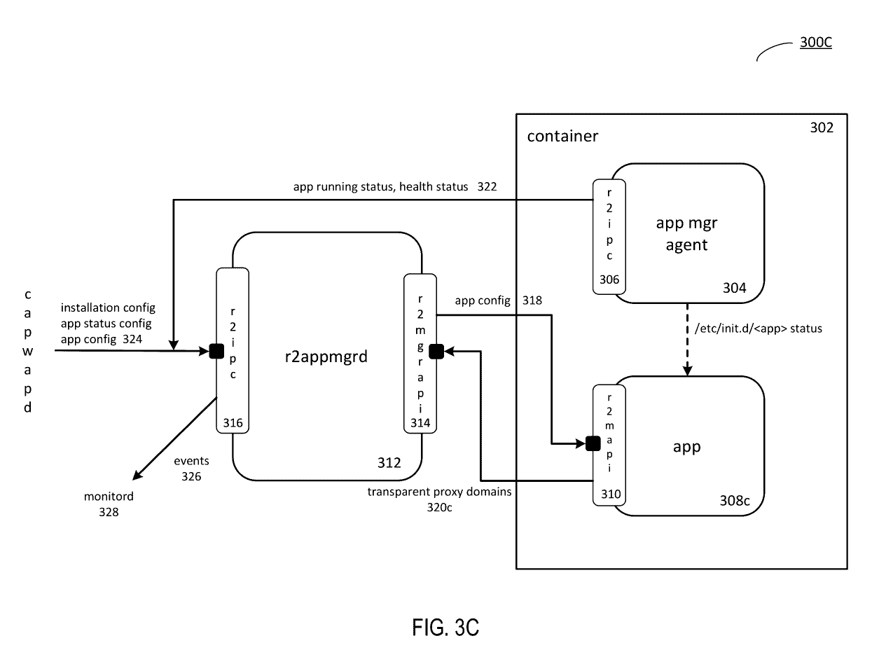

FIG. 3A, 3B and 3C illustrate management of MASE applications, according to certain embodiments. FIG. 3A shows MASE application environment 300A on an AP. FIG. 3A shows container 302 that includes an application manager agent 304, and MASE application 308. Application manager agent 304 communicates with the AP's application manager daemon 312 via inter-process communication (ipc) 316. For example, application manager agent 304 monitors CPU usage, memory usage (e.g., RAM usage), and disk usage of the MASE application 308. Application manager daemon 312 handles problems locally at the AP based on pre-determined policies, for example. Application manager agent 304 communicates information 322 (such as application running status, health status) to application manager daemon 312. Application manager agent 304 also communicates relevant information with MASE application 308. MASE application 308 uses MASE API 310 to communicate information 320 (e.g., application events) to application manager daemon 312 via MASE manager API 314. MASE application 308 receives application configuration information 318 from application manager daemon 312 via MASE manager API 314 and MASE API 310. Further, application manager daemon 312 communicates event information 326 to the monitor daemon 328 on the AP. Also, application manager daemon 312 can receive information 324 (e.g., installation configuration information, application status configuration information, application configuration information) from the cloud-based NMS, according to certain embodiments.

FIG. 3B shows a different embodiment of application manager agent 304b. Application manager agent 304b includes a MASE DPI API 307 that can receive information such as application configuration and application status configuration (318, 318b) from MASE manager DPI API 314b. Further, application manager agent 304b uses API 309 to communicate (e.g., DPI information) with MASE application 308. MASE application 308 uses MASE DPI API 310b to send buffer file upload 320b to application manager daemon 312 through MASE manager DPI API 314b.

FIG. 3C shows a different embodiment of MASE application 308c, which uses MASE API 310 to communicate transparent proxy domain information 320c to application manager daemon 312 via MASE manager API 314.

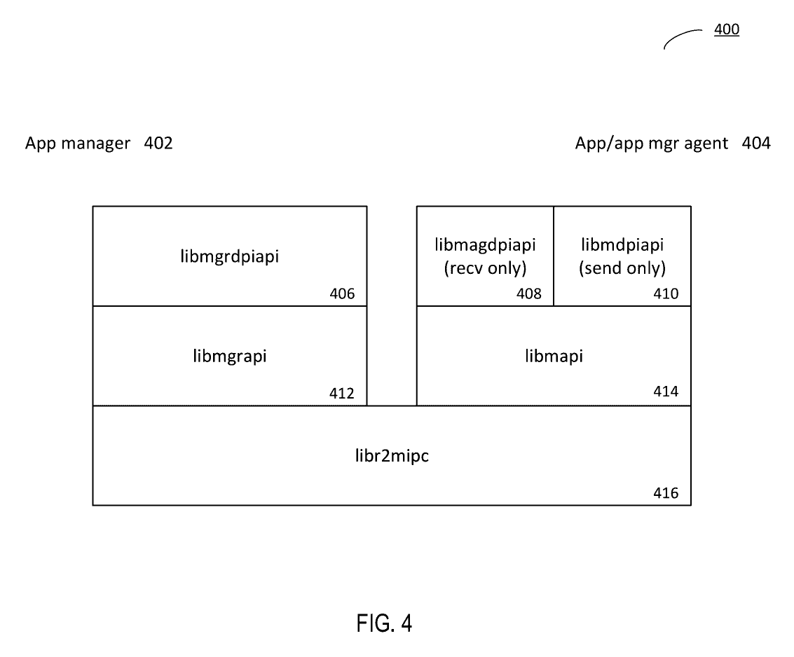

FIG. 4 illustrates MASE libraries to support MASE applications installed in a given AP device, according to certain embodiments. FIG. 4 shows application manager library layers 402 and Application/application manager agent library layers 404 in a MASE library architecture 400, according to certain embodiments. Application manager library layers 402 are not exposed to third party developers and comprise a private dpi library layer 406, and a private API library layer 412. Application/application manager agent library layers 404 comprise a receive-only DPI library layer 408 a send-only DPI library layer 410, and an API library layer 414, according to certain embodiments. FIG. 4 also shows a communication transport layer 416 for IPC messages, according to certain embodiments.

FIG. 5 illustrates segregation of a portion of the AP file system to confine MASE applications, according to certain embodiments. FIG. 5 shows the file system 500 of a given AP. According to certain embodiments, file system 500 comprises: 1) selected directories 502 that can be shared with the MASE application container, via hard links 520, 2) proprietary directories 504 that are not shared with the MASE application container, and 3) the container file system 506. Container file system 506 uses change root (chroot) for all guest processes (directories 508, and 510). According to certain embodiments, even though the proprietary directories 504 are not shared with the MASE application container, the proprietary directories 504 include a virtual disk partition in the form of a disk image that contains the writeable disk space to which a given MASE application container can write data. Mount 522 is a Linux process for making the virtual disk partition accessible by the MASE applications through regular Linux filesystem management commands (e.g., commands related to creating files, writing to a file, creating subdirectories, etc.). In other words, the MASE applications on the AP device has access to such a virtual disk partition. The embodiments are not limited to Linux-type file systems. The file systems may vary from implementation to implementation.

According to certain embodiments, a method of WiFi networking comprises: deploying containerized applications (MASE applications) on a wireless access point device of a plurality of wireless access point devices that are associated with a WiFi network for connecting a plurality of wireless client devices to a wired network. The method comprises using at least one application container on the AP device. The method further comprises installing one or more third party applications in the at least one application container on the AP device. The method further comprising using an AP device that includes: 1) a WLAN chipset on the AP device, which WLAN chipset is capable of connecting at least about 50 wireless client devices at the same time to the wired network that is associated with the AP device (preferably, the WLAN chipset is capable of connecting at least 100 wireless client devices to the wired network that is associated with the AP device), 2) a stand-alone multi-core CPU (central processing unit) on the AP device, which stand-alone multi-core CPU is capable of hosting relevant WiFi related connection services for wireless client devices, as well as capable of hosting/supporting MASE applications, 3) a high-speed and large RAM memory on the AP device, which RAM memory is capable of hosting MASE applications on the AP device, 4) high-speed and large permanent storage on the AP device for supporting MASE applications and for storing large amounts of cached data to support better web-services delivery, 5) dedicated network processor on the AP device, which dedicated network processor is capable of analyzing and controlling IP data packets and for controlling data traffic to achieve reasonable wirespeed in the associated wired network but without adversely impacting CPU cycles of the AP's CPU and without adversely impacting the run-time performance of the MASE applications that are running on the AP device. The method further comprises using a pre-allocated segregated disk space within a file system on the AP device that can be accessed and used by the containerized applications that are installed on the AP device. The method further comprises using an application run-time management system on the AP device to monitor the execution of the containerized third party applications and including monitoring the CPU usage, RAM usage, disk storage usage, application running status, application health status, and application events. The method further comprises using a MASE application programming interface (MASE API) on the AP device to provide web services to the MASE applications installed on the AP device and to provide deep packet inspection services to the MASE applications installed on the AP device.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

We claim:

1. A wireless access point device comprising:
a dedicated network processor;
at least one application container; and
an application manager application that monitors one or more third party applications after the one or more third party applications are installed in the at least one application container;
wherein the at least one application container includes a mobile application services engine API.

2. The wireless access point device of claim 1, further comprises a container file system for use by the one or more third party applications in the application container, wherein the container file system is confined to a pre-allocated segregated disk space within a file system of the wireless access point device.

3. The wireless access point device of claim 1, further comprises a plurality of application services that can be accessed by the one or more third party applications in the application container through the mobile application services engine API.

4. The wireless access point device of claim 3, wherein the plurality of application services that can be accessed by the one or more third party applications in the application container through the mobile application services engine API include http proxy services.

5. The wireless access point device of claim 3, wherein the plurality of application services that can be accessed by the one or more third party applications in the application container through the mobile application services engine API include FCGI web hosting services.

6. The wireless access point device of claim 3, wherein the plurality of application services that can be accessed by the one or more third party applications in the application container through the mobile application services engine API include deep packet inspection services.

7. The wireless access point device of claim 2, wherein the container file system prevents the one or more third party applications from accessing disk space outside the container file system.

8. The wireless access point device of claim 1, further comprises a WLAN chipset capable of connecting more than fifty wireless client connections to a wired network at the same time.

9. The wireless access point device of claim 1, further comprises a stand-alone multi-core CPU.
